(19) United States
(12) Patent Application Publication
(10) Pub. No.: US 2024/0256864 A1
(43) Pub. Date: Aug. 1, 2024

(54) HETEROGENEOUS PRODUCT AUTOENCODERS FOR CHANNEL-ADAPTIVE NEURAL CODES OF LARGE DIMENSIONS

(71) Applicant: Samsung Electronics Co., Ltd., Suwon-si (KR)

(72) Inventors: Mohammad Vahid Jamali, Nashville, TN (US); Hamid Saber, San Diego, CA (US); Homayoon Hatami, San Diego, CA (US); Jung Hyun Bae, San Diego, CA (US)

(21) Appl. No.: 18/429,821

(22) Filed: Feb. 1, 2024

Related U.S. Application Data
(60) Provisional application No. 63/442,675, filed on Feb. 1, 2023.

(51) Int. Cl. G06N 3/08; G06N 3/045

(52) U.S. Cl. CPC G06N 3/08; G06N 3/045

(57) ABSTRACT

A method of training an autoencoder that includes encoder neural networks and decoder neural networks. The method includes training the encoder neural networks in which weights of the decoder neural networks are fixed. The method also includes iteratively training the decoder neural networks for a number of iterations. For each iteration of the training of the decoder neural networks, a pair of decoder neural networks is replaced by another pair of neural networks, and a second decoder neural network of the pair of decoder neural networks utilizes different parameters than a first decoder neural network of the pair of decoder neural networks.

### CROSS-REFERENCE TO RELATED APPLICATION(S)

This application claims priority to and the benefit of U.S. Provisional Patent Application No. 63/442,675, filed in the United States Patent and Trademark Office on Feb. 1, 2023, the entire disclosure of which is incorporated by reference herein. The present application is related to U.S. patent application Ser. No. 17/942,064, filed in the United States Patent and Trademark Office on Sep. 9, 2022, the entire disclosure of which is incorporated by reference herein.

### BACKGROUND

### 1. Field

Aspects of embodiments of the present disclosure relate to channel encoders and decoders implemented using trained neural networks.

### 2. Description of the Related Art

Channel encoders and decoders improve the reliability of communication systems when transmitting and receiving data over a noisy communication channel. Generally, an encoder implementing an error correction code (or error correcting code ECC) takes an original message as input and generates an encoded message, where the encoded message has some additional bits of data in comparison to the original message (e.g., the encoded message is longer than the original message). These additional bits of data provide redundancy such that, if the encoded message is corrupted or otherwise modified between being transmitted from an encoder and being received at a decoder, the decoder can use the additional data to reconstruct the original message, within some limits on the number of errors that can be corrected in accordance with the ECC that is applied to the original message. Examples of classical error correction codes include Reed-Solomon codes, Turbo codes, low-density parity-check (LDPC) codes, and polar codes.

Recently, the encoder and decoder (or some components within the encoder and decoder architectures) have been replaced with neural networks or other trainable models, which reduces the encoding and decoding complexity, improves upon the performance of classical channel codes, enables applications for realistic channel models and emerging use cases, and enables designing universal decoders that simultaneously decode several codes. However, the size of the code spaces (2k distinct codewords for a binary linear code of dimension k) present a major technical challenge in the channel coding context. Due to these large code spaces, only a small fraction of all codewords will be seen during the training phase, and thus the trained models for the encoders and decoders may fail in generalizing to unseen codewords. Additionally, a straightforward design of neural encoders and decoders for large code dimensions and lengths requires using huge networks with excessively large number of trainable parameters. Together, these factors make it prohibitively complex to design and train relatively large neural channel encoders and decoders. Another major challenge is the joint training of the encoder and decoder due to local optima that may occur as a result of non-convex loss functions.

The above information disclosed in this Background section is only for enhancement of understanding of the present disclosure, and therefore it may contain information that does not form the prior art that is already known to a person of ordinary skill in the art.

### Summary

The present disclosure relates to various embodiments of a method of training an autoencoder that includes encoder neural networks and decoder neural networks. In one embodiment, the method includes training the encoder neural networks. Weights of the decoder neural networks are fixed during the training of the encoder neural networks. The method also iteratively training the decoder neural networks for a number of iterations. For each iteration of the training of the decoder neural networks, a pair of decoder neural networks is replaced by another pair of neural networks, and a second decoder neural network of the pair of decoder neural networks utilizes different parameters than a first decoder neural network of the pair of decoder neural networks.

The second decoder neural network may utilize a larger blocklength than the first decoder neural network.

The second decoder neural network may utilize a smaller rate than the first decoder neural network.

Iteratively training the decoder neural networks may include training all of the decoder neural networks for each of a first number of iterations; training only a single pair of decoder neural networks for each of a second number of iterations after the first number of iterations; and training all of the decoder neural networks for each of a third number of iterations after the second number of iterations.

The noisy channel may be a first type of channel, and the method may further include retraining the autoencoder on a second type of channel different than the first type of channel.

The first type of channel may be an additive white Gaussian noise (AWGN) channel, and the second type of channel may be a Rayleigh fading channel.

Retraining the autoencoder may include performing a single training epoch on the second type of channel.

The signal-to-noise ratio may be a first signal-to-noise ratio in a first range, and the method may further include retraining the autoencoder for a number of epochs over the noisy channel having a second signal-to-noise ratio different than the first signal-to-noise ratio.

The second signal-to-noise ratio may be larger than the first signal-to-noise ratio.

The second signal-to-noise ratio may be a wider range than the first signal-to-noise ratio.

The number of epochs may be 11 epochs.

The message may have a code dimension of at least 300 bits.

Training the encoder neural networks may include applying power normalization.

Training the decoder neural networks may include applying power normalization.

The present disclosure also relates to various embodiments of an autoencoder. In one embodiment, the autoencoder includes a number of encoder neural networks configured to map a message to a codeword and to transmit the codeword over a noisy channel having a signal-to-noise ratio, and a number of decoder neural networks configured to decode the message. A second decoder neural network of the pair of decoder neural networks utilizes different parameters than a first decoder neural network of the pair of decoder neural networks.

The second decoder neural network may utilize a larger blocklength than the first decoder neural network.

The second decoder neural network may utilize a smaller rate than the first decoder neural network.

The autoencoder may be trained on a first type of channel and on a second type of channel different than the first type of channel.

The first type of channel may be an additive white Gaussian noise (AWGN) channel, and the second type of channel may be a Rayleigh fading channel.

The autoencoder may be trained on a noisy channel having a first signal-to-noise ratio and a second signal-to-noise ratio different than the first signal-to-noise ratio.

This summary is provided to introduce a selection of features and concepts of embodiments of the present disclosure that are further described below in the detailed description. This summary is not intended to identify key or essential features of the claimed subject matter, nor is it intended to be used in limiting the scope of the claimed subject matter. One or more of the described features may be combined with one or more other described features to provide a workable system or method.

### BRIEF DESCRIPTION OF THE DRAWINGS

The accompanying drawings, together with the specification, illustrate example embodiments of the present invention, and, together with the description, serve to explain the principles of the present invention.

FIG. 1 is a block diagram of a communication system according to one embodiment of the present disclosure;

FIG. 2 is a block diagram of encoder architecture according to one embodiment of the present disclosure;

FIG. 3 is a block diagram of decoder architecture according to one embodiment of the present disclosure;

FIG. 4 is a flowchart illustrating tasks of a method of retraining a product autoencoder on a channel having a larger and wider range of signal-to-noise ratios according to one embodiment of the present disclosure; and

FIG. 5 is a flowchart illustrating tasks of a method of retraining a product autoencoder on a different channel type according to one embodiment of the present disclosure.

### DETAILED DESCRIPTION

The present disclosure relates to various embodiments of a large-scale product autoencoder including an encoding artificial neural network and a decoding artificial neural network, and methods of training a product autoencoder on large code dimensions, such as 300 bits of information or more. The encoding artificial neural network and the decoding artificial neural network are trained for a large code using smaller code components (i.e., the present disclosure trains the encoding artificial neural network and the decoding artificial neural network on smaller code components rather than directly training the encoding artificial neural network and the decoding artificial neural network for a large code). Additionally, the training scheme of the present disclosure utilizes a heterogeneous decoder training scheme in which more powerful codes (e.g., different parameters, such as larger blocklengths or smaller code rates) are utilized for one decoder neural network than the other decoder neural network. The present disclosure also includes training schemes to reduce (e.g., remove) the error floor in the performance of the product autoencoder by retraining the product autoencoder with larger values and a wider range of the training signal-to-noise ratios (SNRs). The present disclosure further includes a method of fine-tuning the product autoencoder by retraining the product autoencoder on a different channel type than it was originally trained (e.g., retraining a product autoencoder that was trained on an additive white Gaussian noise (AWGN) channel on a Rayleigh fading channel model).

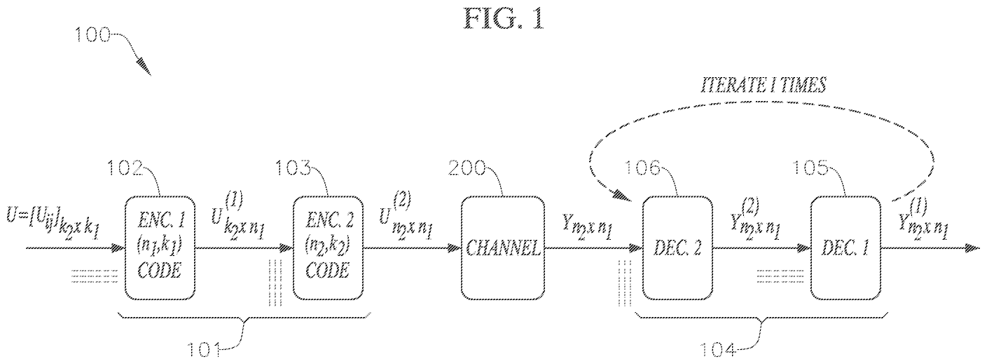

FIG. 1 depicts an autoencoder communication system 100 for transmitting and receiving information across a noisy channel 200 (e.g., an additive white Gaussian noise (AWGN) channel). In the illustrated embodiment, the autoencoder communication system 100 includes an encoder 101 including a first encoder 102 and a second encoder 103, and a decoder 104 that includes a first decoder 105 and a second decoder 106. In the illustrated embodiment, the first encoder 102, the second encoder 103, the first decoder 104, and the second decoder 105 are each fully-connected artificial neural networks (FCNNs) (i.e., the autoencoder 100 includes a first encoder FCNN 102, a second encoder FCNN 103, a first decoder FCNN 105, and a second decoder FCNN 106). The first encoder FCNN 102 and the second encoder FCNN 103 are parametrized with a set of weights ϕ₁ and ϕ₂, respectively, and the first decoder FCNN 105 and the second decoder FCNN 106 are parametrized with a set of weights θ₁ and θ₂, respectively. Each of the first and second encoder FCNNs 102, 103 has an input size of kⱼ, an output size of nⱼ, and L_{encj} hidden layers of size N_{encj}, where j=1 for the first encoder FCNN 102 and j=2 for the second encoder FCNN 103.

FIG. 1 depicts the transmission of a length-k (e.g., a k-bit) sequence of information bits u across the noisy channel 200. The encoder FCNNs 102, 103 map the information bits u to a length-n sequence of coded symbols c=E(u), known as a codeword, wherein k and n are the code dimension and blocklength, respectively, and the resulting code is denoted by an (n, k) code. FIG. 1 depicts an example of a two-dimensional (n, k) product code that is constructed from two smaller codes: C₁:(n₁, k₁) and C₂:(n₂, k₂), where n=n₁n₂ and k=k₁k₂. The first encoder FCNN 102 implements the (n₁, k₁) code C₁, and the second encoder FCNN 103 implements the (n₂, k₂) code C₂. As noted above, k=k₁k₂ and therefore the k-bit input codeword U can be reshaped into a k₂×k₁ matrix. Because each row of the matrix has k₁ symbols, the first encoder FCNN 102 applies the (n₁, k₁) code C₁ independently to each of the k₂ rows of the input to generate a k₂×n₁ matrix U_{k2×k1}⁽¹⁾. This first intermediate encoded message U_{k2×k1}⁽¹⁾ is supplied to the second encoder FCNN 103. Here, because each column of the first intermediate encoded message U_{k2×k1}⁽¹⁾ has k₂ symbols, the second encoder FCNN applies 103 the (n₂, k₂) code C₂ independently to each column to generate an n₂×n₁ output matrix U_{n2×n1}⁽²⁾. Because this is a two-dimensional product code, there are only two encoder FCNNs 102, 103 (i.e., there are no further stages in this pipeline of encoder stages), and this n₂×n₁ output matrix U_{n2×n1}⁽²⁾ is the length n coded message to be transmitted on or over the channel 200. In one or more embodiments in which the product code is a three-dimensional product code or larger, an i-th stage encoder FCNN implements a code Cᵢ:(nᵢ, kᵢ) where nᵢ is a factor of n and kᵢ is a factor of k.

Noise and other interference in the channel 200 can modify the data in the output matrix U_{n2×n1}⁽²⁾ transmitted by the second encoder FCNN 103. The noisy signal can be expressed as y=c+n, where n is the channel noise vector (independent from c) whose components are Gaussian random variables with mean zero and variance σ². The ratio of the average energy per coded symbol to the noise variance is the signal-to-noise ratio (SNR). In one or more embodiments, the encoder FCNNs 102, 103 satisfy a soft power constraint such that the average power per coded bit is equal to 1 and the SNR=1/σ².

Additionally, as shown in FIG. 1, the first and second decoder FCNNs 105, 106 decode the message (i.e., the noisy signal y) in the reverse order in which the first and second encoder FCNNs 102, 103 applied the codes C₁ and C₂. In the example shown in FIG. 1, the first encoder FCNN 102 applied code C₁ and then the second encoder FCNN 103 applied code C₂. Accordingly, the second decoder FCNN 106 is first applied for code C₂ (e.g., to decode each column of n₂ symbols) and then the first decoder FCNN 105 is applied for code C₁ (e.g., to decode each row of n₂ symbols).

In the example shown in FIG. 1, applying the decoder FCNNs 105, 106 does not change the shape of the data. For example, applying the second decoder FCNN 106 to the columns of the n₂×n₁ input results in an n₂×n₁ second intermediate decoder output Yₙ_{₂}_{×n}_{₁}⁽²⁾ and applying the first decoder FCNN 105 to the rows of the second intermediate decoder output Yₙ_{₂}_{×n}_{₁}⁽²⁾ produces a first intermediate decoder output Yₙ_{₂}_{×n}_{₁}⁽¹⁾ having dimensions n₂×n₁. As such, an extraction circuit may be used to extract a length-k sequence (e.g., k₂×k₁ matrix) from the first intermediate decoder output Yₙ_{₂}_{×n}_{₁}⁽¹⁾.

In addition, in some embodiments, decoding performance can be improved by applying a soft-input soft-output (SISO) decoder and also performing several iterations, where the output of the product decoder 104 (e.g., the output of the last decoder stage, in this case the first decoder FCNN 105 as shown in FIG. 1) is fed back as input to the product decoder 104 (e.g., the input to the second decoder FCNN 106 as shown in FIG. 1) for some set number of iterations (I iterations) before extracting the estimated message û from the output of the product decoder 104. These iterations I can improve the decoding performance because, in some circumstances, errors that were not corrected during a row decoding might be corrected in a later column decoding (or vice versa) or after several iterations (e.g., reconstructing some lost data may enable other, previously not reconstructable, lost data to be subsequently reconstructed).

While the above discussion of FIG. 1 relates to a two-dimensional code, product codes are not limited thereto and can also be applied to M-dimensional product codes having parameters (n, k, d) that uses M binary linear block codes C₁, C₂, . . . , C_{M}. Here, each l-th encoder encodes the l-th dimension of the M-dim input matrix, and each l-th decoder decodes the vectors on the l-th dimension of the M-dim output matrix. In each code (e.g., an l-th code Cₗ:(nₗ, kₗ, dₗ)) with generator matrix Gₗ for l=1, 2, . . . , M, the parameters of the resulting product code are:
Block-length: n=Πₗ₌₁^{M}nₗ
Dimension: k=Πₗ₌₁^{M}kₗ
Rate: R=Πₗ₌₁^{M} Rₗ
Minimum distance: d=Πₗ₌₁^{M} dₗ
Generator matrix: G=G₁⊗G₂⊗ . . . ⊗G_{M}, where ⊗ is the Kronecker product operator.

In one or more embodiments, the encoder FCNNs 102, 103 and the decoder FCNNs 105, 106 may be components of the same computer system (e.g., integrated within a single enclosure, such as in the case of a smartphone or other mobile device, tablet computer, or laptop computer), may be separate components of a computer system (e.g., a desktop computer in communication with an external monitor), or may be separate computer systems (e.g., two independent computer systems communicating over the communication channel), or variations thereof (e.g., implemented within special purpose processing circuits such as microcontrollers configured to communicate over the communication channel, where the microcontrollers are peripherals within a computer system). In one or more embodiments, the encoder FCNNs 102, 103 and the decoder FCNNs 105, 106 may be implemented on different communication devices of the communication system and that communicate with one another over a communication channel. For example, the encoder FCNNs 102, 103 may be implemented in user equipment such as a smartphone and the decoder FCNNs 105, 106 may be implemented in a base station. In one or more embodiments, these communication devices are transceivers that can both transmit and receive data. For example, a smartphone may include both the encoder FCNNs 102, 103 and the decoder FCNNs 105, 106 for transmitting and receiving data, respectively, where these may implement the same neural codes (e.g., same error correction codes) or different neural codes (e.g., different error correction codes).

In various embodiments, the encoder FCNNs 102, 103 and the decoder FCNNs 105, 106 may be implemented by processing circuits of a communication device. In one or more embodiments, the various processing circuits may be components of a same integrated circuit (e.g., as being components of a same system on a chip or SoC) or may be components of different integrated circuits that may be connected through pins and lines on a printed circuit board. Additionally, in one or more embodiments, the encoder circuit may be implemented using a different type of processing circuit than the decoder circuit. Examples of processing circuits include, but are not limited to, a general-purpose processor core (e.g., included within application processors, system-on-chip processors, and the like), a central processing unit (CPU), an application processor (AP) or application processing unit (APU), a field programmable gate array (FPGA which may include a general-purpose processor core), an application specific integrated circuit (ASIC) such as a display driver integrated circuit (DDIC), a digital signal processor (DSP), a graphics processing unit (GPU), a neural accelerator or neural processing unit, and combinations thereof (e.g., controlling an overall encoding or decoding process using a general-purpose processor core that controls a neural accelerator to perform neural network operations such as vector multiplications and accumulations and to apply non-linear activation functions). The encoder FCNNs 102, 103 and the decoder FCNNs 105, 106 may be defined in accordance with an architecture and a plurality of parameters such as weights and biases of connections between neurons of different layers of the neural networks of various neural stages of the encoder FCNNs 102, 103 and the decoder FCNNs 105, 106. In some embodiments of the present disclosure, these parameters may be stored in memory and accessed by the processing circuits during runtime to perform computations implementing the neural stages. In some embodiments of the present disclosure, the processing circuit is configured with these parameters (e.g., fixed in a lookup table or as constant values in a special-purpose DSP, ASIC, FPGA, or neural processing unit).

In one or more embodiments, the communication link may be a wireless communication link such as a cellular connection or a local wireless network connection (e.g., Wi-Fi connection) between a client mobile device (e.g., smartphone, laptop, or other user equipment (UE)) and a base station (e.g., gNodeB or gNB in the case of a 5G-NR base station or a Wi-Fi access point or Wi-Fi router), where the devices may transmit and receive data over the communication channel using processing circuits according to the present disclosure integrated into the respective devices, where the data is formatted or encoded and decoded in accordance with a communication protocol (e.g., a cellular communication protocol such as 6G wireless or a wireless networking communication protocol such as a protocol in the IEEE 802.11 family of protocols).

Algorithm 1 below depicts a process of training the autoencoder 100 according to one embodiment of the present disclosure. The weights ϕ₁, ϕ₂ and θ₁, θ₂ of the first and second encoder FCNNs 102, 103 and the first and second decoder FCNNs 105, 106, respectively, are initialized and the process of training the autoencoder 100 includes performing E training epochs. For each training epoch e of the total number of training epochs E, the process includes a decoder training schedule in which the decoder FCNNs 105, 106 are trained for T_{dec} iterations, and an encoder training schedule in which the encoder FCNNs 102, 103 are trained for T_{enc} iterations. During the encoder training schedule, the decoder FCNNs 105, 106 remain fixed, and during the decoder training schedule the encoder FCNN 102, 103 remain fixed (i.e., the weights θ₁, θ₂ of the decoder FCNNs 105, 106 remaining fixed during the training of the encoder FCNNs 102, 103, and the weights ϕ₁, ϕ₂ of the encoder FCNNs 102, 103 remain fixed during the training of the decoder FCNNs 105, 106).

As illustrated below, for each training iteration id of the total number of training iterations T_{dec} the decoder FCNNs 105, 106, a batch of B message words are generated and the encoder FCNNs 102, 103 are utilized to generate codewords C from the message words in which the code dimensions are K={k₁, k₂ . . . , k_{M}} and the blocklengths are N={n₁, n₂ . . . , n_{M}}. The process of training the decoder FCNNs 105, 106 also includes generating a batch of B noise vectors with signal-to-noise ratios (SNRs) from the range [γ_{d,1}, γ_{d,u}] (i.e., generate N) and then generating a batch of noisy codewords (i.e., Y=C+N) using the noise vectors, which represent the noise of the communication channel 200. The process of training the decoder FCNNs 105, 106 also includes generating decoded sequences Û utilizing the decoder FCNNs 105, 106 and then applying an optimizer to update the weights Θ of the decoder FCNNs 105, 106 while keeping the weights ϕ of the encoder FCNNs 102, 103 fixed.

Additionally, as illustrated below, for each training iteration iₑ of the total number of training iterations T_{enc} of the encoder FCNNs 102, 103, a batch of B message words are generated and the encoder FCNNs 102, 103 are utilized to generate codewords C from the message words. The process of training the encoder FCNNs 102, 103 also includes generating a batch of B noise vectors with signal-to-noise ratio (SNR) γₑ (i.e., generate N) and then generating a batch of noisy codewords (i.e., Y=C+N) using the noise vectors. The process of training the encoder FCNNs 102, 103 also includes generating decoded sequences Û utilizing the decoder FCNNs 105, 106 and then applying an optimizer to update the weights ϕ of the encoder FCNNs 102, 103 while keeping the weights Θ of the decoder FCNNs 105, 106 fixed. In this manner, the weights ϕ and θ of the first and second encoder FCNNs 102, 103 and the first and second decoder FCNNs 105, 106 are determined.

Algorithm 1 ProductAE Training Algorithm

Input: Dimension of ProductAE M, Set of code dimensions [symbol] := {k₁, k₂, ... ,k_{M}} and blocklengths [symbol]
:= {n₁, n₂, ... ,n_{M}}, number of epochs E, batch size [symbol] , number of encoder and decoder training
iterations T [symbol] and T [symbol] encoder training SNR [symbol] , decoder training SNR range [ [symbol] ], and encoder
and decoder learning rates [symbol] and [symbol]
Output: Encoder and decoder NN weights ϕ and Θ.

| 1: | Initialize ϕ and Θ | |
|---|---|---|
| 2: | for e = 1, ... ,E do | [symbol] perform E training epochs |
| 3: | for [symbol] = 1, ... ,T [symbol] do | [symbol] decoder training schedule |
| 4: | U ← generate a batch of [symbol] message words | |
| 5: | C ← ProductAE_Enc(U, ϕ, [symbol] , [symbol] ) | |
| 6: | N ← gencrate a batch of [symbol] noise vectors with SNRs from the range [symbol] | |
| 7: | Y ← C + N | [symbol] batch of noisy codewords |
| 8: | Û ← ProductAE_Dec(Y, Θ, [symbol] , [symbol] ) | |
| 9: | Θ ← Optimizer( [symbol] (U, Û), Θ, [symbol] ) [symbol] apply the optimizer to update Θ while keeping ϕ | |
| | fixed | |
| 10: | end for | |
| 11: | for [symbol] = 1, ... , T [symbol] do | [symbol] encoder training schedule |

| | |
|---|---|
| 12: | U ← generate a batch of [symbol] message words |
| 13: | C ← ProductAE_Enc(U, ϕ, [symbol] , [symbol] ) |
| 14: | N ← a batch of B noise vectors with SNR [symbol] |
| 15: | Y ← C + N |
| 16: | Û ← productAE_Dec(Y, Θ, [symbol] , [symbol] ) |
| 17: | ϕ ← optimizer( [symbol] (U, Û), ϕ, [symbol] ) [symbol] apply the optimizer to update ϕ while keeping Θ |
| | fixed |
| 18: | end for |
| 19: | end for |
| 20: | return ϕ and Θ |

[symbol]

indicates data missing or illegible when filed

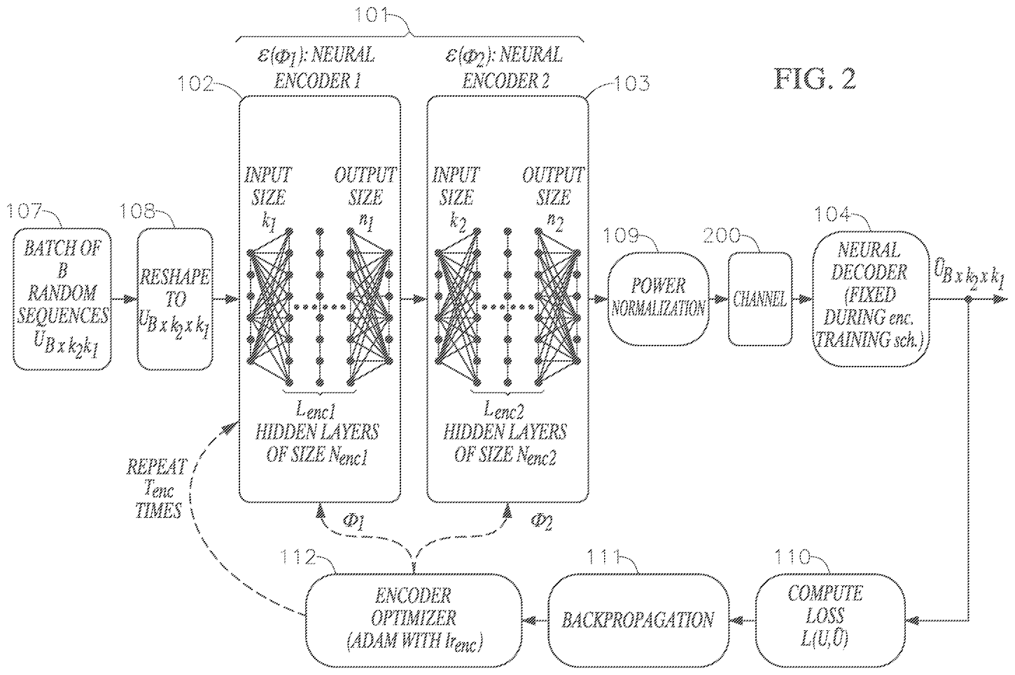

FIG. 2 is a block diagram illustrating a scheme for training the encoder FCNNs 102, 103 (e.g., a two-dimensional product autoencoder (M=2) including a first encoder FCNN (E₁(ϕ₁)) and a second encoder FCNN (E₂(ϕ₂)) of the communication system 100 for transmitting data over the noisy communication channel 200 (e.g., an AWGN) channel) according to one embodiment of the present disclosure.

During a process of training the first and second encoder FCNNs 102, 103, a batch of B length-k₁k₂ binary information sequences 107 is reshaped to a tensor U_{B×k}_{₂}_{×k}_{₁} 108 to fit the first and second encoder FCNNs 102, 103. In response to receiving the tensor U_{B×k}_{₂}_{×k}_{₁} 108 as an input, the first encoder FCNN 102 maps each length-k₁ row to a length-n₁ real-valued vector, resulting in a tensor U_{B×k}_{₂}_{×n}_{₁}⁽¹⁾ that is sent or transmitted to the second encoder FCNN 103. In response to receiving the tensor U_{B×k}_{₂}_{×n}_{₁}⁽¹⁾; the second encoder FCNN 103 maps each real-valued length-k₂ vector in the second dimension of the tensor U_{B×k}_{₂}_{×n}_{₁}⁽¹⁾ to a length-n₂ real-valued vector. In one or more embodiments, the mappings may be nonlinear mappings such that the resulting code is nonlinear and non-binary code.

In the illustrated embodiment, the length-n₂ real-valued vector (i.e., the codeword) is output by the second encoder FCNN 103 to a power normalization task or process 109. The power normalization task 109 is configured to ensure that the average power per coded bit is equal to one and thus the average SNR is equal to the given SNR. In the illustrated embodiment, the length-n real-valued vector c=(c₁, c₂, . . . , cₙ) of the coded sequence at the output of the second encoder FCNN 103 is normalized as follows:

$$c \to {c}^{′} := \frac{c}{{‖ c ‖}_{2}} \times \sqrt{n} .$$

Therefore, ∥c′∥₂²=n, and thus the average power per coded symbol is equal to one.

After the input is encoded by the first and second encoder FCNNs 102, 103 and the coded sequence is normalized by the power normalization function 109, the real-valued codewords C are passed through the channel 200 (e.g., the AWGN channel) and then decoded using the decoder 104 to generate a batch of decoded codewords Û_{B×k}_{₂}ₖ_{₁} (after appropriate reshaping). As described above, the weights θ of the decoder 104 are fixed during this process. Additionally, as illustrated in FIG. 2, the process includes computing the loss between the transmitted and decoded sequences L(U, Û) 110, backpropagating the loss to compute its gradients 111, and then updating the weights ϕ₁, ϕ₂ of the first and second encoder FCNNs utilizing an encoder optimizer (Adam with Ir_{enc}) 112. This process is repeated T_{enc} times while each time only updating the weights ϕ₁, ϕ₂ of the first and second encoder FCNNs 102, 103 while the weights θ of the decoder 104 remain fixed.

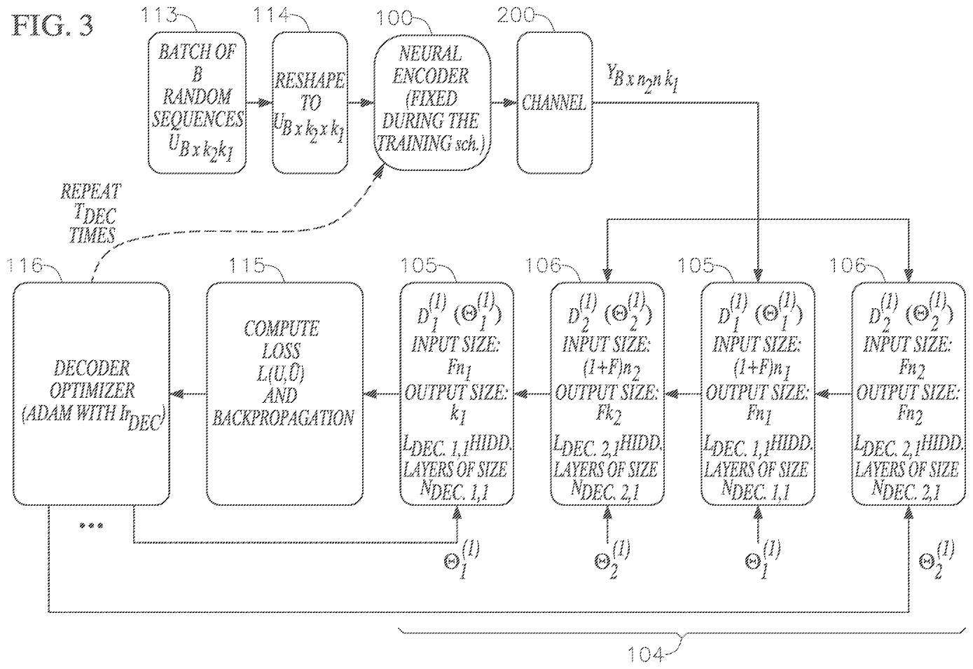

FIG. 3 is a block diagram illustrating a scheme for training the decoder FCNNs 105, 106 (e.g., a two-dimensional product autoencoder (M=2) including first decoder FCNN (D₁(θ₁) and second decoder FCNN (D₂θ₂)) of the communication system 100 for receiving data over the noisy communication channel 200 (e.g., an AWGN channel) according to one embodiment of the present disclosure.

As illustrated in FIG. 3, a batch of B random sequences U_{B×k}_{₂}ₖ_{₁} 113 are reshaped into binary information sequences U_{B×k}_{₂}_{×k}_{₁} 114. For each epoch of the decoder training schedule, the reshaped binary information sequences U_{B×k}_{₂}_{×k}_{₁} are encoded into real-valued codewords utilizing the encoder 101 (e.g., the first and second encoder FCNNs 102, 103). During this process, the weights ϕ₁, ϕ₂ of the encoder FCNNs 102, 103 are fixed. The real-valued codewords are then passed through the channel 200 (e.g., the AWGN channel), with a range of decoder training signal-to-noise ratios (SNR) to generate a batch of noisy codewords Y_{B×n}_{₂}_{×n}_{₁}. The noisy codewords Y_{B×n}_{₂}_{×n}_{₁} are then decoded using the decoder FCNNs 105, 106 to generate a batch of decoded codewords Û_{B×k}_{₂}ₖ_{₁}. For each training epoch, the decoder FCNNs 105, 106 are trained for/iterations.

As illustrated in FIG. 3, the pair of decoder FCNNs 105, 106 are replaced at each i-th iteration (i=1, 2, . . . I) with a pair of distinct decoder FCNNs (i.e., another pair of decoder FCNNs), which results in a total number of decoder FCNNs 105, 106 of 2×I (i.e., the process of training the decoder FCNNs 105, 106 includes performing I decoding iterations in which each iteration i utilizes a distinct pair of decoder FCNNs 105, 106). In FIG. 3, the decoder FCNNs 105, 106 are denoted Dⱼ⁽ⁱ⁾, where j=1, 2. Each of the decoder FCNNs 105, 106 are parametrized by a set of weights Θⱼ⁽ⁱ⁾. At each decoding iteration i, the decoding is first performed by the second decoder FCNN D₂ 106 and then by the first decoder FCNN D₁ 105. Because the decoding is first performed by the second decoder FCNN D₂ 106, the second decoder FCNN D₂ 106 is expected to observe noisier (less reliable) codewords than the first decoder FCNN D₁ 105. Accordingly, in one or more embodiments, the process of training the decoder FCNNs 105, 106 includes utilizing more powerful codes (e.g., different parameters, such as larger blocklengths or smaller code rates) for C₂ compared to C₁. For example, in one or more embodiments, the training process may include utilizing larger blocklengths and/or smaller code rates for C₂ compared to C₁.

Additionally, as illustrated in FIG. 3, the process includes computing the loss between the transmitted and decoded sequences L(U, Û) and backpropagating the loss to compute its gradients 115, and then updating the weights Θ₁, Θ₂ of the first and second decoder FCNNs utilizing a decoder optimizer (Adam with Ir_{dec}) 116. This process is repeated T_{dec} times while each time only updating the weights Θ₁, Θ₂ of the first and second decoder FCNNs 105, 106 while the weights ϕ of the encoder 101 (e.g., the first and second FCNNs 102, 103) remain fixed.

As described above, the process of training the decoder FCNNs 105, 106 includes I decoding iterations in which each iteration i utilizes a distinct pair of decoder FCNNs 105, 106. As such, the decoder FCNNs 105, 106 have a relatively more complex network with more learnable parameters compared to the encoder FCNNs 102, 103. This greater complexity and number of learnable parameters may be utilized to improve the performance of the decoder FCNNs 105, 106 by performing separate decoder training schedules per epoch. That is, in one or more embodiments, the process of training the decoder FCNNs 105, 106 includes a multi-schedule training process. In one or more embodiments, the multi-schedule training process includes a first schedule in which all of the decoder FCNNs 105, 106 are trained together for T_{dec,s} iterations. During the next I schedules or iterations, only a single pair of decoder FCNNs 105, 106, corresponding to a given decoding iteration, is updated. Afterward, another full decoder training schedule takes place in which all of the decoder FCNNs 105, 106 are trained together for T_{dec,e} iterations. Finally, the encoder FCNNs 102, 103 are updated for T_{enc} iterations. In one or more embodiments, this multi-schedule training process speeds up the process of training the decoder FCNNs 105, 106 compared to a training process in which the decoder FCNNs 105, 106 are not trained in this manner.

Aspects of the present disclosure also relate to training methods for increasing the robustness and the adaptivity of the product autoencoder 100. Robustness refers to the ability of an autoencoder trained over a particular channel model to perform well on a different channel model without retraining, and adaptivity refers to the ability of an autoencoder to retrain for (i.e., adapt to) a different channel model with minimal retraining. For instance, applying a product autoencoder trained for AWGN channels to a fading channel model may result in error rate saturation for larger signal-to-noise ratio (SNR) values, which results in an error floor. This saturation of the performance is due to the training SNRs of the encoder and the decoder being in a range that does not include any (or at least does not include a significant number of) noisy samples with the large channel SNRs of the fading channel model.

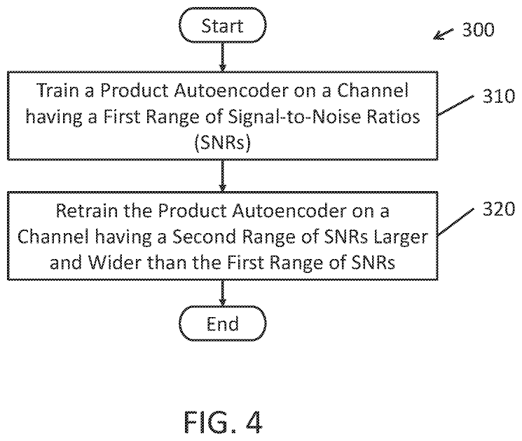

In the embodiment illustrated in FIG. 4, the method 300 includes a task 310 of training a product autoencoder on a channel (e.g., an AWGN channel) having a first range of signal-to-noise ratios (SNRs), and a task 320 of re-training the product autoencoder on a channel with larger values and wider range of the training SNRs for a few epochs (e.g., a number of epochs from 2 to 20). In this manner, retraining the product autoencoder with larger values and wider range of the training SNRs eliminates or at least reduces the performance saturation behavior at higher SNRs (e.g., eliminates the error floor). In one or more embodiments, the task 320 of fine-tuning the product autoencoder trained for the AWGN channel with larger values and wider ranges of the training SNRs decreases the performance saturation behavior such that the error floor disappears (or substantially disappears) after 11 training epochs with the larger and wider ranges of the SNRs.

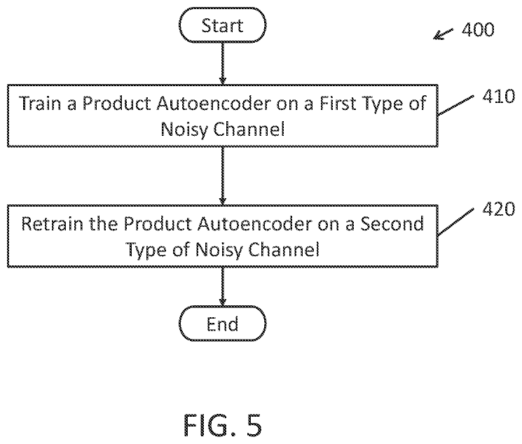

Aspects of the present disclosure also relate to methods for fine-tuning a product autoencoder that was trained on one channel type to fully adapt to another channel model type. For instance, in the embodiment depicted in FIG. 5, the method 400 includes a task 410 of training a product autoencoder on a first type of noisy channel (e.g., an AWGN channel) and a task 420 of training the autoencoder on a second type of noisy channel (e.g., Rayleigh fading channel model) different than the first type of noisy channel. In one or more embodiments, the task 420 of training the product autoencoder on the second task may be performed for only a single training epoch, only two training epochs, or only a few training epochs. In one or more embodiments, a product autoencoder that was trained over the AWGN model was fine-tuned to achieve excellent performance over the Rayleigh fading channel model by training the product autoencoder with only one full epoch over the Rayleigh fading channel model. In this manner, a product autoencoder may be trained to perform well over multiple channel models by fine-tuning the product autoencoder that was trained on one channel type for one epoch (or two or more epochs) over a different channel model, rather than fully retraining the product autoencoder on the new channel model. In one or more embodiments, these fine-tuned product autoencoders deliver almost the same performance as fully re-trained product autoencoders. Additionally, in one or more embodiments, the task 420 of fine-tuning does not degrade the performance of the fine-tuned product autoencoder over the AWGN channel when the fine-tuning is performed for a relatively small number of epochs, such as 20 or fewer epochs (e.g., 15 or fewer epochs, or 10 or fewer epochs).

Algorithm 2 below depicts the process of generating codewords utilizing the encoder FCNNs 102, 103 and the power normalizer 109 according to one embodiment of the present disclosure. As illustrated below, a batch of input information sequences U are reshaped to an M-dimensional array according to the set of code dimensions K={k₁, k₂ . . . , k_{M}}. Additionally, the process includes applying the m-th encoder FCNN 101 to the m-dimension of the input information sequence U to map the length kₘ vectors to length nₘ vectors. The process also includes a task of reshaping each array in the batch of input information sequences U to a sequence of length n=n₁n₂ . . . n_{M}, and then a task of applying the power normalizer function 109 to generate the codewords C.

Algorithm 2 ProductAE Encoder Function ProductAE_Enc

Input: Batch of input information sequences U, set of code dimensions [symbol] := {k₁, k₂, ... ,k_{M}} and
blocklengths [symbol] := {n₁, n₂, ... ,n_{M}}, and encoder NNs
Output: Batch of codewords C.

| | |
|---|---|
| 1: | U ← reshape each sequence of bits in U to an M-dimensional array according to the dimensions |
| | set [symbol] |
| 2: | for m = 1, ... ,M do |
| 3: | U ← apply the m-th NN encoder to the m-dimension of U to map length-kₘ vectors to length-nₘ |
| | vectors |
| 4: | end for |
| 5: | C₁ ← reshape each array in the batch U to a sequence of length n = n₁n₂...n_{M} |
| 6: | C ← PowerNormalizer(C₁) |
| 7: | return C |

Algorithm 3 below depicts the process of decoding the noisy codewords Y (i.e., the codewords C output by the encoder FCNNs 101 and the noise from the noisy channel 200) with the decoder FCNNs 105, 106 according to one embodiment of the present disclosure. As illustrated below, the first I−1 pairs of decoder FCNNs 105, 106 work on input and output sizes of the length of coded bits nⱼ, and the last pair of decoder FCNNs 105, 106 (i.e., the I-th pair of decoder FCNNs 105, 106) reverts the encoding operation by reducing the lengths from nⱼ to kⱼ. In one or more embodiments, some of the decoder FCNNs 105, 106 may take multiple length-n; vectors as input and output multiple copies of length-nⱼ vectors. In Algorithm 3, the function “reshape” reshapes the tensor upon which the function is being applied to the shape specified by the function arguments. Moreover, the function “concatenate([X, Y], l)” constructs a larger tensor by concatenating two tensors X and Y in dimension l. Finally, the function “permute” returns a new tensor by permuting the dimensions of the original tensor according to the specified arguments. Although the decoding algorithm in Algorithm 3 is for two-dimensional product autoencoders (M=2), the decoding algorithm may be generalized to higher-dimensional (M-dimensional) product autoencoders.

Algorithm 3 Decoder Function of 2-Dimensional ProductAEs ProductAE_Deg_2D

Input: Batch of noisy codewords Y, set of code dimensions k₁, k₂ and blocklengths n₁, n₂, number of
decoding iterations I, and decoder NNs
Output: Batch of decoded sequences Û.

| | | |
|---|---|---|
| 1: | Y ← Y.reshape(B, n₁, n₂) | [symbol] reshape Y to a 3D tensor |

| | |
|---|---|
| 2: | if I == 1 then |
| 3: | Y [symbol] ← Y |
| 4: | else |
| 5: | for i = 1, ... ,I − 1 do |
| 6: | if i == 1 then |
| 7: | Y₂ ← [symbol] [symbol] (Y).reshape(B, Fn₁, n₂) |
| 8: | else |
| 9: | Y [symbol] ← [symbol] [symbol] (Y [symbol] ) |
| 10: | Y₂ ← (Y [symbol] − Y [symbol] ).reshape(B, Fn₁, n₂) |
| 11: | end if |
| 12: | Y [symbol] ← concatenate([Y, Y₂],1).permute(0,2,1) |
| 13: | Y [symbol] ← [symbol] [symbol] (Y [symbol] ).permute(0,2,1) |
| 14: | Y [symbol] ← (Y₁ − Y₂).reshape(B, n₁, Fn₂) |
| 15: | Y [symbol] ← concatenate([Y, Y [symbol] ], 2) |
| 16: | end for |
| 17: | end if |
| 18: | Y₂ ← [symbol] [symbol] (Y [symbol] ).reshape(B, Fn₁, k₂) |
| 19: | Y₁ ← [symbol] [symbol] (Y₂).permute(0,2,1)) |
| 20: | Û ← Y₁.reshape(B, k₁k₂) |
| 21: | return Û |

[symbol]

indicates data missing or illegible when filed

It should be understood that the sequence of steps of the processes described herein in regard to various methods and with respect various flowcharts is not fixed, but can be modified, changed in order, performed differently, performed sequentially, concurrently, or simultaneously, or altered into any desired order consistent with dependencies between steps of the processes, as recognized by a person of skill in the art. Further, as used herein and in the claims, the phrase “at least one of element A, element B, or element C” is intended to convey any of: element A; element B; element C; elements A and B; elements A and C; elements B and C; and elements A, B, and C.

Embodiments of the present invention can be implemented in a variety of ways as would be appreciated by a person of ordinary skill in the art, and the term “processor” as used herein may refer to any computing device capable of performing the described operations, such as a programmed general purpose processor (e.g., an ARM processor) with instructions stored in memory connected to the general purpose processor, a field programmable gate array (FPGA), and a custom application specific integrated circuit (ASIC). Embodiments of the present invention can be integrated into a serial communications controller (e.g., a universal serial bus or USB controller), a graphical processing unit (GPU), an intra-panel interface, and other hardware or software systems configured to transmit and receive digital data.

While the present invention has been described in connection with certain example embodiments, it is to be understood that the invention is not limited to the disclosed embodiments, but, on the contrary, is intended to cover various modifications and equivalent arrangements included within the spirit and scope of the appended claims.

What is claimed is:

1. A method of training an autoencoder comprising a plurality of encoder neural networks and a plurality of decoder neural networks, the method comprising:
training the plurality of encoder neural networks, wherein weights of the plurality of decoder neural networks are fixed during the training of the plurality of encoder neural networks;
iteratively training the plurality of decoder neural networks for a plurality of iterations, wherein, for each iteration of training the plurality of decoder neural networks:
a pair of decoder neural networks of the plurality of decoder neural networks are replaced by another pair of neural networks of the plurality of decoder neural networks are, and
a second decoder neural network of the pair of decoder neural networks utilizes different parameters than a first decoder neural network of the pair of decoder neural networks.

2. The method of claim 1, wherein the second decoder neural network utilizes a larger blocklength than the first decoder neural network.

3. The method of claim 1, wherein the second decoder neural network utilizes a smaller rate than the first decoder neural network.

4. The method of claim 1, wherein the iteratively training the plurality of decoder neural networks comprises:
training all of the plurality of decoder neural networks for each of a first number of iterations of the plurality of iterations;
training only a single pair of decoder neural networks for each of a second number of iterations of the plurality of iterations after the first number of iterations; and
training all of the plurality of decoder neural networks for each of a third number of iterations of the plurality of iterations after the second number of iterations.

5. The method of claim 1, wherein the plurality of encoder neural networks is configured to map a message to a codeword and to transmit the codeword over a noisy channel, wherein the noisy channel is a first type of channel, and wherein the method further comprises retraining the autoencoder on a second type of channel different than the first type of channel.

6. The method of claim 5, wherein the first type of channel is an additive white Gaussian noise (AWGN) channel, and wherein the second type of channel is a Rayleigh fading channel.

7. The method of claim 5, wherein the retraining of the autoencoder comprises performing a single training epoch on the second type of channel.

8. The method of claim 1, wherein the plurality of encoder neural networks is configured to map a message to a codeword and to transmit the codeword over a noisy channel having a signal-to-noise ratio, wherein the signal-to-noise ratio is a first signal-to-noise ratio in a first range, and wherein the method further comprises retraining the autoencoder for a plurality of epochs over the noisy channel having a second signal-to-noise ratio different than the first signal-to-noise ratio.

9. The method of claim 8, wherein the second signal-to-noise ratio is larger than the first signal-to-noise ratio.

10. The method of claim 9, wherein the second signal-to-noise ratio is a wider range than the first signal-to-noise ratio.

11. The method of claim 8, wherein the plurality of epochs comprises 11 epochs.

12. The method of claim 1, wherein the plurality of encoder neural networks is configured to map a message to a codeword and to transmit the codeword over a noisy channel having a signal-to-noise ratio, and wherein the message has a code dimension of at least 300 bits.

13. The method of claim 1, training the plurality of encoder neural networks comprises applying power normalization.

14. The method of claim 1, training the plurality of decoder neural networks comprises applying power normalization.

15. An autoencoder comprising:
a plurality of encoder neural networks configured to map a message to a codeword and to transmit the codeword over a noisy channel having a signal-to-noise ratio; and
a plurality of decoder neural networks configured to decode the message, wherein a second decoder neural network of the pair of decoder neural networks utilizes different parameters than a first decoder neural network of the pair of decoder neural networks.

16. The autoencoder of claim 15, wherein the second decoder neural network utilizes a larger blocklength than the first decoder neural network.

17. The autoencoder of claim 15, wherein the second decoder neural network utilizes a smaller rate than the first decoder neural network.

18. The autoencoder of claim 15, wherein the autoencoder is trained on a first type of channel and on a second type of channel different than the first type of channel.

19. The autoencoder of claim 18, wherein the first type of channel is an additive white Gaussian noise (AWGN) channel, and wherein the second type of channel is a Rayleigh fading channel.

20. The autoencoder of claim 15, wherein the autoencoder is trained on a noisy channel having a first signal-to-noise ratio and a second signal-to-noise ratio different than the first signal-to-noise ratio.
